(19) United States
(12) Patent Application Publication
(10) Pub. No.: US 2026/0051101 A1
(43) Pub. Date: Feb. 19, 2026

(54) ATTENTION MAP CORRECTION FOR GARMENT ANIMATION GENERATION

(71) Applicant: Adobe Inc., San Jose, CA (US)

(72) Inventors: Swasti MISHRA, Bhilai (IN); Kuldeep KULKARNI, Bagalkot (IN); Duygu CEYLAN AKSIT, London (GB); Balaji Vasan SRINIVASAN, Bengaluru (IN)

(73) Assignee: Adobe Inc., San Jose, CA (US)

(21) Appl. No.: 18/807,068

(22) Filed: Aug. 16, 2024

(51) Int. Cl. G06T 13/40; G06V 10/75

(52) U.S. Cl. CPC G06T 13/40; G06V 10/751

(57) ABSTRACT

Embodiments are disclosed for generating an animated garment video. The method may include receiving a text prompt describing a garment by a diffusion model. The diffusion model generates an animation corresponding to the text prompt. The animation includes a sequence of frames generated by the diffusion model depicting the garment in motion. A frame of the sequence of frames is generated using a flow map of the frame, an attention map of a previous frame, and an attention map of the frame.

### BACKGROUND

Dynamic images can be more engaging to a user than static images. An image can be dynamic when at least one portion of the image moves. For instance, garments worn by a person depicted in the image can be blowing in the wind, making the image a dynamic image.

### SUMMARY

Introduced here are techniques/technologies that generate high quality animations of garments, including high-frequency garments (e.g., garments with complex patterns, complex designs, repetitive patterns) and highly reflective garments (e.g., garments made of reflective material such as satin). The garment animation system of the present disclosure is able to generate a temporally coherent sequence of frames used to depict an animated garment by suppressing artifacts in no-motion regions across frames.

More specifically, in one or more embodiments, the garment animation system modifies the self-attention maps of a diffusion model to enhance the quality of the garment animation, making the animation look more natural while suppressing spurious animation generated by the diffusion model. Specifically, cross-frame self-attention features are injected into attention maps of a UNet based diffusion model, such as a normal conditioned ControlNet, to increase the temporal coherence of the generated frames of a video sequence. The self-attention maps are further modified using the optical flow obtained from a sequence of normal maps. As a result, spurious motion generated by the diffusion model is corrected using modified attention maps. The animation of the garment is obtained in a training-free manner. That is, the modification of the attention maps in a normal-conditioned ControlNet model enables the ControlNet model to generate a sequence of frames, which, when combined, produce an animation of the garment, without any additional training performed on the ControlNet model.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating a garment animation, in accordance with one or more embodiments;

FIG. 2 illustrates an example implementation of the text-to-image generative model, in accordance with one or more embodiments;

FIG. 3 illustrates the diffusion processes used to train the diffusion model, in accordance with one or more embodiments;

FIG. 4 illustrates an example of a portion of a text-to-image generative model, in accordance with one or more embodiments;

FIG. 5 illustrates a schematic diagram of a garment animation system in accordance with one or more embodiments;

FIG. 6 illustrates a flowchart of a series of acts in a method of generating an animation of a garment, in accordance with one or more embodiments; and

FIG. 7 illustrates a block diagram of an exemplary computing device in accordance with one or more embodiments.

### DETAILED DESCRIPTION

One or more embodiments of the present disclosure include a garment animation system used to generate an animation of a garment. Some conventional systems generate an animation of a garment using non-machine learning methods. For example, some conventional systems generate an animation of a garment by decomposing the garment into a shading map and a reflectance map. The shading map corresponds to the normal map, which in turn is animated and eventually is composited with the reflectance map to animate the movement of the garment. In such conventional systems, this composition of shading and reflectance can provide an illusion of motion without actually warping the texture of the garment, resulting in smoothed textures. In other words, high-frequency text patterns on a garment are smoothed out in the animation of the garment, changing the aesthetics of the textured garment.

Other conventional systems use generative machine learning models and stable diffusion to generate an animation of a garment. For example, ControlNet is a diffusion model that is configured to generate an image using a text prompt and a control, where the control defines a texture, edge, boundary, or other property of the garment that is not to be generated or modified by ControlNet. However, using ControlNet to animate a garment inadvertently causes erroneous motion. For example, such conventional systems animate a garment and also generate erroneous background motion, unnatural/erroneous garment motion, and unnatural/erroneous facial expressions of a person in the animation. In other words, applying ControlNet for every frame separately can cause temporal inconsistencies in the garment texture as well as the background.

Attempts to maintain temporal consistency across the animation can include self-attention feature injection and cross-frame feature injection, which reduces erroneous motion such as background motion, texture motion, and facial motion of an input image including a garment. While the erroneous motion is reduced, such motion is still present in the animation and visually detracts from the target garment motion. Additionally, the self-attention feature injection and cross-frame feature injection can cause unnatural garment motion (e.g., garment warping).

To address these and other deficiencies in conventional systems, the garment animation system of the present disclosure creates animations of garments without adding visual artifacts like other conventional systems. Attention maps are correlated with the final garment animation. Accordingly, by correcting attention maps, the garment generation system of the present disclosure generates garment animation that is temporally coherent and suppresses spurious motion such as background motion, unnatural or erroneous garment motion, and/or unnatural or erroneous facial expressions of people in in the generated animation. In operation, attention maps are corrected by injecting cross-frame attention maps and flow maps into the attention map of a UNet based diffusion model (e.g., normal conditioned ControlNet).

Improving the visual aesthetics of garment animation reduces computing resources that would otherwise be consumed re-running conventional garment animation systems that generate inaccurate garment animations. For example, as described herein, some garment animation systems generate animated garments that visually change the garment to be animated by smoothing any patterns on the animated garment. Additionally or alternatively, some garment animation systems generate animated garments with distracting background motion. By deploying the garment animation system described herein to generate animations of garments, software resources are not consumed fixing or otherwise adjusting low-quality or otherwise inaccurate garment animations. Additionally or alternatively, the improved accuracy of garment animations using the garment animation system described herein reduces computing resources that would otherwise be consumed re-running conventional segmentation systems that generate low-quality or otherwise inaccurate garment animations. The garment animation system of the present disclosure performs garment animations less often, as a result of more accurate garment animations, conserving power, bandwidth, memory, and other computing resources.

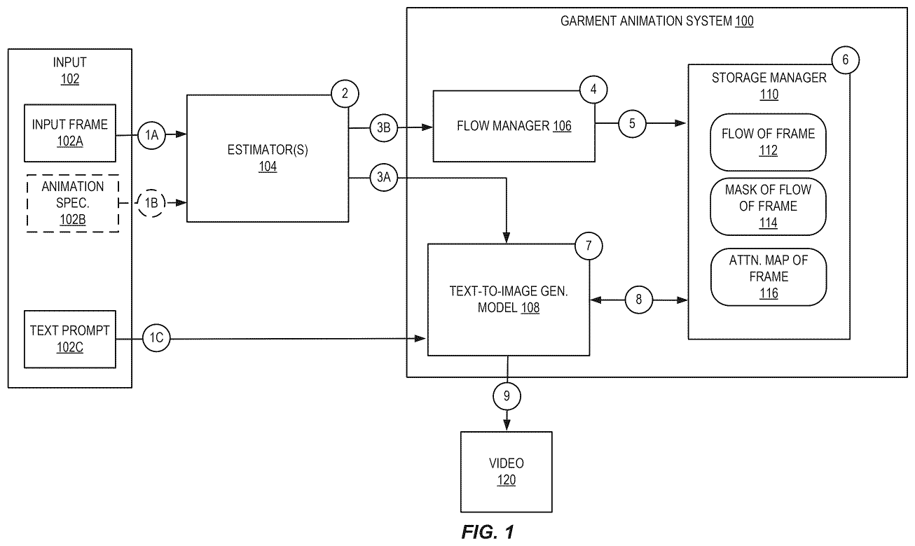

FIG. 1 illustrates a diagram of a process of generating a garment animation, in accordance with one or more embodiments. A garment animation is a sequence of frames (e.g., a video) that, when presented to a user, visually cause the garment to appear in motion. For ease of description, a garment, as used herein, refers to clothing that is worn by a human. However, it should be appreciated that a garment can refer to any clothing (e.g., clothing worn by inanimate objects such as dolls, clothing worn by pets or animals) and can include clothing that is not worn (e.g., hanging). As shown in FIG. 1, a garment animation system 100 can generate an animation of a clothing garment using a text prompt 102C and a text-to-image generative model 108. The garment animation system 100 may be implemented as a standalone system, such as an application executing on a client computing device, server computing device, or other computing device. In some embodiments, the garment animation system 100 may be implemented as a tool incorporated into another system, service, application, etc. to animate garment. The garment animation system 100 may be implemented in a user device, in a service provider device as part of a cloud computing model, or other device which may receive text and return output videos.

In some embodiments, a user may provide inputs 102 including an input frame 102A, animation specifics 102B, and a text prompt 102C. Although embodiments are described as receiving inputs from and returning outputs to a user, in various embodiments the inputs may be received from another system or other entity (such as an intervening system between the end user and the garment animation system 100). The input frame 102A can include an image depicting a garment. The animation specifics 102B define a speed of movement, a direction or movement, and other movement-based properties of a garment to be animated. In some embodiments, if the input frame 102A includes multiple garments, the animation specifics 102B identifies one or more garments to be selected for animation. The text prompt 102C can be a natural language description of a type of garment (e.g., shirt, dress, pants), a texture (e.g., leopard spotted, flower print, plain), and an object adorning the garment (e.g., a person). Example text prompt 102C can include “a man wearing a striped shirt” or “a women in a red satin dress with flowers.”

At numerals 1A and 1B, the input frame 102A and the animation specifics 102B are passed to one or more estimators 104. In some embodiments, the input frame 102A and the animation specifics 102B are passed to the estimator(s) 104 at numeral 1A and 1B respectively during a first time period. For example, an administrator can provide the input frame 102A and the animation specifics 102B during an initialization period. During the initialization period, the estimator(s) 104 generate a sequence of normal maps and corresponding flow maps, as described herein. Subsequently, a user provides the text prompt 102C to the garment animation system 100 during a second time period. For example, the text prompt 102C can be input to the garment animation system 100 at numeral 1C during use, by a user, of an application or web-browser that calls the garment animation system 100 during run-time.

At numeral 2, one or more estimators 104 can receive the input frame 102A and perform one or more operations. The estimator(s) 104 can use any one or more models to generate a sequence of normal maps using the input frame 102A. For example, given the input frame 102A, a machine learning model, such as a generative adversarial network (GAN) can generate a sequence of normal maps.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In some embodiments, the machine learning model used to generate the sequence of normal maps is Wind Cyclic UNet from CycleNet. The optional animation specifics 102B received by the one or more estimators 104 at numeral 1B can include animation specifics such as a selection of a particular garment to be animated, a direction of animation, and a speed of animation.

A normal map captures information about the surface of an object (e.g., a garment). For example, in a RGB image (e.g., input frame 102A), each channel (e.g., Red, Green, Blue) can correspond to a dimension X, Y, Z of each surface normal of the garment. A sequence of normal maps can capture a warping or movement of the surface of the garment. Specifically, the sequence of normal map describes garment motion dynamics that involve geometry variations like folds and wrinkles responsive to garment motion. In other words, the sequence of normal maps defines the animation of the garment desired in the output video 120. The sequence of normal maps includes a normal map for each frame of a video sequence. The sequence of normal maps is passed to the text-to-image generative model 108 at numeral 3A. In some embodiments, the sequence of normal maps is stored in storage manager 110 and passed to the text-to-image generative model 108 at numeral 3A during run-time. As described herein, each normal map of the sequence of normal maps corresponds to a frame of the output video 120.

Also at numeral 2, the estimator(s) 104 can use any one or more models to compute an optical flow using the sequence of normal maps. The optical flow (referred to herein as “flow”) represents an estimation of per-pixel motion between a pair of consecutive normal maps in the sequence of normal maps. Specifically, a flow map represents an intensity value of each pixel, where the intensity value of the pixel corresponds to speed of motion of the pixel across a pair of frames. In some embodiments, a machine learning model such as the Recurrent All-Pair Field Transformers (RAFT) is used to determine the optical flow of the sequence of normal maps. In some embodiments, for each normal map, the estimator(s) 104 generate a corresponding flow map. The flow F_{C} computed from the sequence of normal maps N_{S} can be mathematically represented according to

$${F}_{C} = {\{ {f}_{c}^{i} \}}_{i = 0}^{N - 1} and {N}_{S} = {\{ {n}_{s}^{i} \}}_{i = 0}^{N - 1}$$

respectively.

In some embodiments, a single estimator can perform the operations described herein. In other embodiments, multiple estimators 104 perform the operations described herein. For example, a first estimator computes the sequence of normal maps from the input frame 102A and a second estimator computes the flow map for each normal map of the sequence of normal maps. While estimator(s) 104 are shown external to the garment animation system 100, in some embodiments, the operations of the estimator(s) can be performed by one or more components of the garment animation system 100.

At numeral 3B, the flow manager 106 receives the flow maps determined by the estimator(s) 104. In some embodiments, the flow manager 106 performs the operations of estimator(s) 104. For example, the flow manager 106 can determine flow maps corresponding to normal maps associated with the input frame 102A. At numeral 4, the flow manager 106 computes a binary mask of the flow map by thresholding the flow map, for example. In operation, the flow manager 106 can compare the intensity value of each pixel in the flow map to a threshold. If the intensity value meets or exceeds a threshold, the flow manager 106 sets the pixel to a value (e.g., a value of “1”). If the intensity value does not meet or exceed the threshold, the flow manager 106 sets the pixel to a value (e.g., a value of “0”). As a result, the flow manager 106 binarizes the flow map, therefore generating a mask of the flow map.

At numeral 5, the flow manager 106 passes a sequence of flow maps corresponding to a sequence of normal maps to the storage manager 110. Also at numeral 5, the flow manager 106 passes the binarized mask of each flow map of the sequence of flow maps to the storage manager 110. It should be appreciated that while storage manager 110 is illustrated as a component within the garment animation system 100, storage manager 110 may be any device external to the garment animation system 100. As described herein, each flow map corresponds to a frame of the video 120. Accordingly, at numeral 6, the storage manager 110 stores a flow map for each frame (e.g., flow of frame 112) and a mask of a flow map of each frame (e.g., mask of flow of frame 114). In some embodiments, the storage manager 110 tags flow maps, masks of flow maps, and/or normal maps based on animation specifics 102B. For example, the storage manager 110 can associate a garment, a garment movement, an object movement (e.g., a person walking) and the like (identified via animation specifics 102B and/or the input frame 102A) with the stored flow maps, masks of flow maps, and/or normal maps. In some embodiments, the operations described at numeral 1A and 1B-5 are performed during an initialization period (e.g., at a time before the garment animation system 100 is called to perform a garment animation).

In some embodiments, the text-to-image generative model 108 receives the text prompt 102C at numeral 1C during a run-time. For example, a user can request the use of the garment animation system 100 via an interactive button displayed at a user interface, for instance. Additionally, the text-to-image generative model 108 receives the sequence of normal maps (or in some embodiments, one normal map from the sequence of normal maps) at numeral 3A during run-time, for instance. In some embodiments, a sequence of normal maps is stored by the storage manager 110 and passed to the text-to-image generative model 108 during run-time based on the text prompt 102C. For example, given a natural language description in text prompt 102C including the description “dress” and “walking,” a sequence of normal maps tagged with “dress” and “walking” is retrieved from the storage manager 110 and passed to the text-to-image generative model 108.

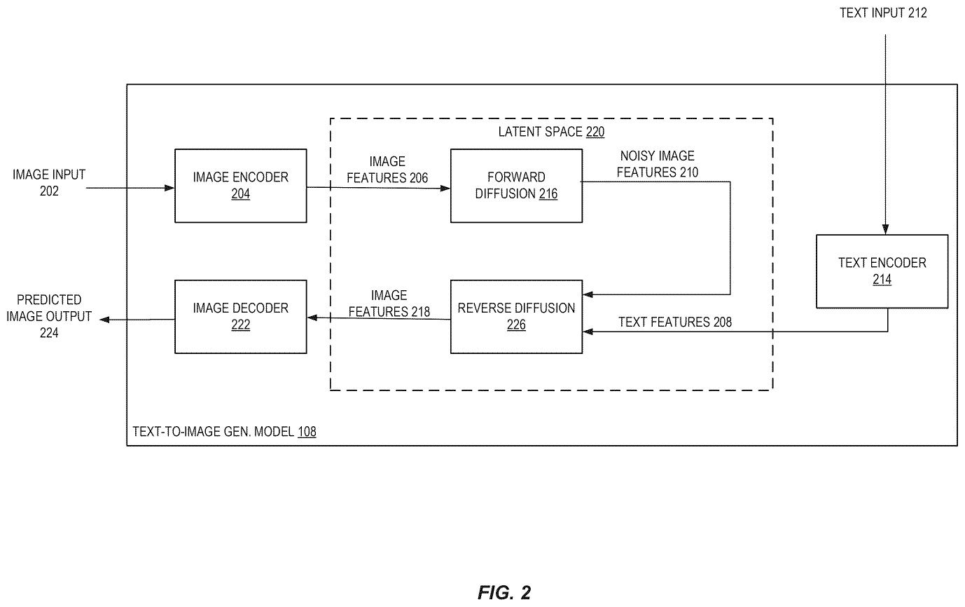

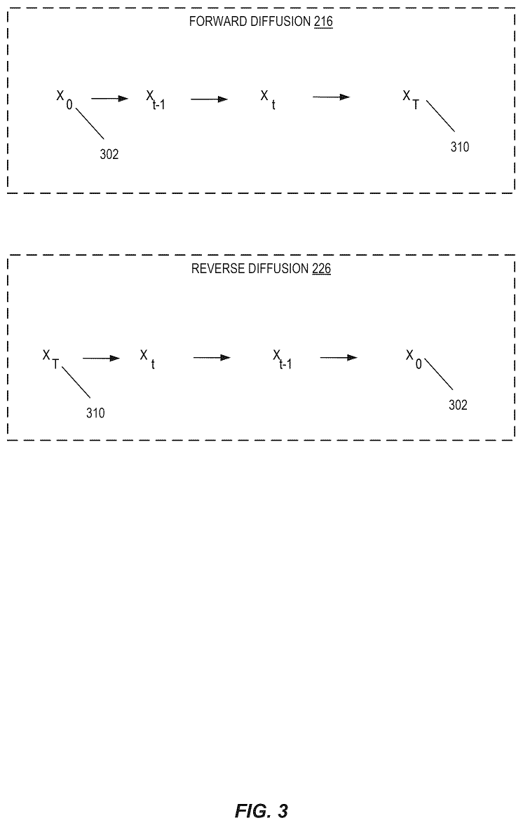

The text-to-image generative model 108 can be any generative model configured to receive a text prompt (e.g., text prompt 102C) at numeral 1C and generate frames (e.g., images) which when combined, become video 120. In some embodiments, the text-to-image generative model 108 is a diffusion model such as ControlNet. ControlNet is a particular diffusion model configured to generate an image given one or more controls, where the control defines a texture, edge, boundary, or other property of the garment (represented via edge maps, poses, normal maps, or depth maps). Diffusion models are described in FIG. 2 and FIG. 3. In some embodiments, the text-to-image generative model 108 is a ControlNet diffusion model conditioned on normal-maps. That is, the text-to-image generative model 108 is a ControlNet diffusion model pretrained with normal-maps as the control.

At numeral 7, the text-to-image generative model 108 generates a frame of video 120 corresponding to a received normal map from the sequence of normal maps and the text prompt 102C. During the frame generation process, the text-to-image generative model 108 determines an attention map. As shown at numeral 8, attention maps determined during the frame generation process are stored in storage manager 110 for use during generation of a next frame. For example, during generation of a frame at time t, the text-to-image generative model 108 determines an attention map associated with the frame at time t. The attention map associated with the frame at time t is stored at the storage manager 110 as an attention map of the frame 116. During generation of a next frame (e.g., at a time t+1), the text-to-image generative model 108 queries the storage manager 110 for the attention map associated with the frame at time t. In other words, the text-to-image generative model 108 queries the storage manager 110 for the attention map of the previous frame.

At numeral 9, a sequence of frames is output from the garment animation system 100 as video 120. The video 120 includes a plurality of frames which, when played, include a moving visual representation of an animated garment. In other words, the generated garment animation (e.g., video 120) includes a sequence of frames depicting the garment in motion. Each frame of the video 120 is an instantaneous image of the video generated by the text-to-image generative model 108.

FIG. 2 illustrates an example implementation of the text-to-image generative model, in accordance with one or more embodiments. As described herein, any generative model can be executed to generate an image related to visual text using the text-to-image generative model. In some embodiments, the text-to-image generative model 108 is a generative model such as a diffusion model.

Generative machine learning involves predicting features for a given label. For example, given a label (or natural prompt description) “cat”, the generative AI module determines the most likely features associated with a “cat.” The features associated with a label are determined during training using a reverse diffusion process in which a noisy image is iteratively denoised to obtain an image. In operation, a function is determined that predicts the noise of latent space features associated with a label.

During a training period, an image (e.g., an image of a cat) and a corresponding label (e.g., “cat”) are used to teach the text-to-image generative model 108 features of a prompt (e.g., the label “cat”). As shown in FIG. 2, an input image 202 and a text input 212 are transformed into latent space 220 using an image encoder 204 and a text encoder 214 respectively. The latent space 220 is a space in which unobserved features are determined such that relationships and other dependencies of such features can be learned. Specifically, latent space is an abstract multi-dimensional space in which data can be compared. Data with similar meanings, features, or characteristics is positioned closer together in latent space than data with dissimilar meanings, features, or characteristics. After the text encoder 214 and image encoder 204 have encoded text input 212 and image input 202 respectively, image features 206 and text features 208 are determined from the image input 202 and text input 212 accordingly. In some embodiments, the image encoder 204 and/or text encoder 214 are pretrained. In other embodiments, the image encoder 204 and/or text encoder 214 are trained jointly.

Once image features 206 have been determined by the image encoder 204, a forward diffusion process 216 is performed according to a fixed Markov chain to inject gaussian noise into the image features 206. The forward diffusion process 216 is described in more detail in FIG. 3. As a result of the forward diffusion process 216, a set of noisy image features 210 are obtained.

The text features 208 and noisy image features 210 are algorithmically combined in one or more steps (e.g., iterations) of the reverse diffusion process 226. The reverse diffusion process 226 is described in more detail in FIG. 3. As a result of performing reverse diffusion, image features 218 are determined, where such image features 218 are similar to image features 206. The image features 218 are decoded using image decoder 222 to predict image output 224. Similarity between image features 206 and 218 may be determined in any way. In some embodiments, instead of comparing similarity between image features, the similarity between images (e.g., image input 202 and predicted image output 224) is determined in any way. The similarity between image features 206 and 218 and/or images 202 and 224 can be used to adjust one or more parameters of the reverse diffusion process 226.

FIG. 3 illustrates the diffusion processes used to train the diffusion model, in accordance with one or more embodiments. The diffusion model may be implemented using any artificial intelligence/machine learning architecture in which the input dimensionality and the output dimensionality are the same. For example, the diffusion model may be implemented according to a UNet neural network architecture.

As described herein, a forward diffusion process adds noise over a series of steps (iterations 1) according to a fixed Markov chain of diffusion. Subsequently, the reverse diffusion process removes noise to learn a reverse diffusion process to construct a desired image (based on the text input) from the noise.

The forward diffusion process 216 starts at an input (e.g., feature X₀ indicated by 302). Each time step t (or iteration) up to a number of T iterations, noise is added to the feature X such that feature X_{T} indicated by 310 is determined. As described herein, the features that are injected with noise are latent space features. If the noise injected at each step size is small, then the denoising performed during reverse diffusion process 226 may be accurate. The noise added to the feature X can be described as a Markov chain where the distribution of noise injected at each time step depends on the previous time step. That is, the forward diffusion process 216 can be

$$q ( {X}_{0} ) = {\prod }_{t = 1}^{T} q ( {X}_{t} \vert {X}_{t - 1} ) .$$

represented mathematically

The reverse diffusion process 226 starts at a noisy input (e.g., noisy feature X_{T} indicated by 310). Each time step t, noise is removed from the features. The noise removed from the features can be described as a Markov chain where the noise removed at each time step is a product of noise removed between features at two iterations and a normal Gaussian noise distribution. That is, the reverse diffusion process 326 can be represented mathematically as a joint probability of a sequence of samples in the Markov chain, where the marginal probability is multiplied by the product of conditional probabilities of the noise added at each iteration in the Markov chain. In other words, the reverse diffusion process 226 is

$${p}_{θ} ( {X}_{0 : T} ) = p ( {X}_{t} ) {\prod }_{t = 1}^{T} {p}_{θ} ( {X}_{t - 1} \vert {X}_{t} ) , where p ( {X}_{t} ) = N ( {X}_{t} ; 0 , 1 ) .$$

During deployment of the diffusion model, the reverse diffusion process is used in generative AI modules to generate images from input text. That is, a latent space representation is progressively denoised using the reverse diffusion process 226 to obtain an intermediate representation of the target image to be generated. Subsequently, images are generated from the intermediate representation using a decoder. In some embodiments, an input image is not provided to the diffusion model.

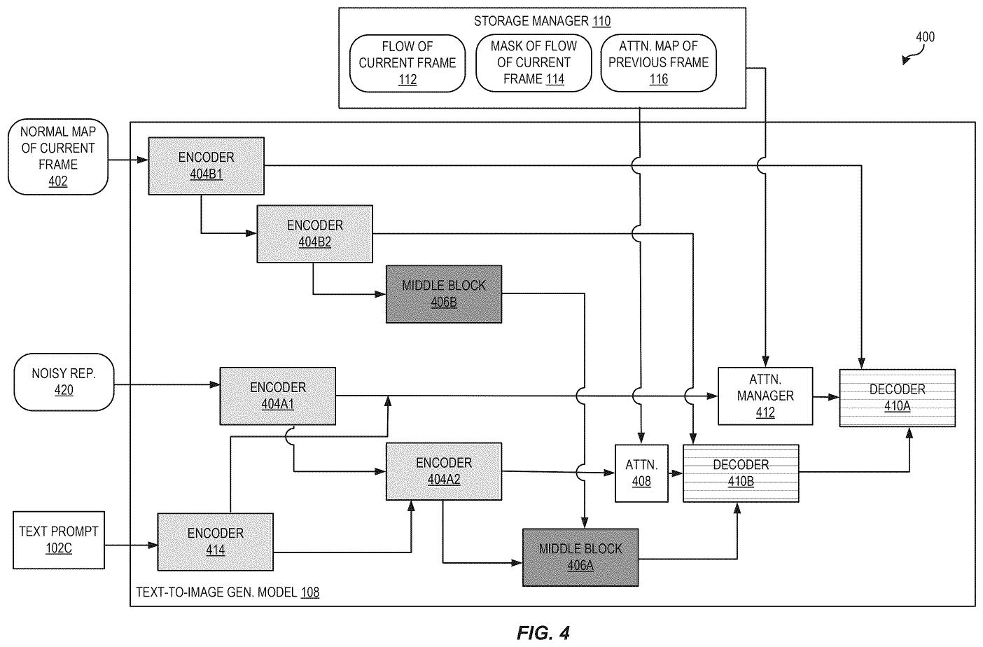

FIG. 4 illustrates an example of a portion of a text-to-image generative model, in accordance with one or more embodiments. In some embodiments, the text-to-image generative model 108 is a diffusion model such as a normal-map conditioned ControlNet.

Given a sequence of normal maps Nₛ and a text prompt, a video sequence with N video frames is generated,

$$V = {\{ {I}^{i} \}}_{i = 0}^{N - 1} ,$$

where each Iⁱ is an image (or a frame of the video sequence) generated by denoising the noisy representation 420. In some embodiments, noisy representation 420 is a Gaussian random noise image such that x_{T}˜N(0, 1). As described herein, the text-to-image generative model 108 progressively denoises the noisy representation 420

$${x}_{T}^{i}$$

over a number of T times steps to obtain

$${x}_{0}^{i} ,$$

which is then decoded to obtain a frame of the video sequence. In operation, for a given denoising step T, noise is subtracted from x_{T} to obtain a frame (also referred to herein as an image) output from the decoder 410A. For each frame of the video sequence Iⁱ, the same noise initialization is used. That is,

$${x}_{T} = {x}_{T}^{i} ∀ i ∈ [ 0 , N - 1 ] .$$

As a result, the noise that is denoised for each frame (e.g., noisy representation 420) is the same. In some embodiments, the input frame 102A can be transformed into the noisy representation 420. For example, random Gaussian noise can be applied to the input frame 102A to obtain noisy representation 420.

The text-to-image generative model 108 in example 400 has a UNet architecture including a contracting portion and expanding portion. The contracting portion of the UNet architecture is defined by encoders (e.g., encoder 404A1 and encoder 404A2). The encoders of the contracting portion of the UNet are collectively referred to herein as encoder 404A. The expanding portion of the UNet architecture is defined by decoders (e.g., decoder 410A and decoder 410B). The decoders of the expanding portion of the UNet are collectively referred to herein as decoders 410. The UNet also has a middle block, indicated by middle block 406A.

As described herein, the text-to-image generative model 108 is configured to receive a control. The input control is a normal map 402 of the sequence of normal maps. As described herein, the normal map 402 is associated with a frame of the video. That is, each normal map of the sequence of normal maps is used to create a frame of the sequence of frames of the video. The normal map 402 is passed to a different contracting portion of the UNet architecture, including encoder 404B1 and encoder 404B2. The text-to-image generative model 108 also has a second middle block, indicated by middle block 406B. The encoder 404B1, encoder 404B2, and middle block 406B define the normal-conditioned portion of the text-to-image generative model 108.

As described herein, the text-to-image generative model 108 is a diffusion model configured to receive a text prompt 102C input. As shown, the text prompt 102C is passed to an encoder 414 configured to extract text features from the text prompt 102C. In some embodiments, the text features (e.g., the output of the encoder 414) is algorithmically combined with the output of encoder 404A1 such that a representation of the text features are passed to the attention manager 412 and encoder 404A2. In this manner, faithfulness to the text prompt 102C is achieved.

Each of the light grey blocks illustrated in text-to-image generative model 108 are encoders (e.g., encoder 404A1, encoder 404B1, encoder 404A2, encoder 404B2 and encoder 414) collectively referred to herein as encoders 404. Each of the dark grey blocks illustrated in text-to-image generative model 108 are middle blocks (e.g., middle block 406A and middle block 406B) collectively referred to herein as middle blocks 406. Each of the hatched blocks illustrated in text-to-image generative model 108 are decoders (e.g., decoder 410A and decoder 410B).

Encoders 404 include one or more convolutional layers and pooling layers which downsample the input to the respective encoder. The result of each encoder 404 is an encoded representation of the input to the encoder, which is a latent space representation of the input to the encoder. Accordingly, the output of encoder 404B1, encoder 404B2, encoder 404A1, and encoder 404A2 is a latent space image representation (e.g., image features), and the output of encoder 414 is a latent space text representation (e.g., text features).

Decoders 410 include one or more convolutional layers that are used to upsample the input to the respective decoder. The result of each decoder 410 is a decompressed representation of the input to the decoder, which is used to generate an image (e.g., a frame of the sequence of frames).

The contracting portion of the text-to-image generative model 108 is used to capture the context of the image to be generated by capturing features of the image using convolution. In the contracting portion, encoders 404 encode their input and pass the encoded representation of the input to a subsequent encoder. Each subsequent encoder of the contraction portion is used to obtain features that more closely correlated to the image to be generated. Accordingly, the initial encoders (e.g., encoder 404A1) may encode the noisy representation 420 using features that are less closely related to the image to be generated than the later encoders (e.g., encoder 404A2) that encode the noisy representation 420 using features that are more closely related to the image to be generated. While only two encoders are shown in the contracting portion of the text-to-image generative model 108 (e.g., encoder 404A1 and encoder 404A2), more or fewer encoders may be implemented by the text-to-image generative model 108.

In the expanding portion of the text-to-image generative model, decoders 410 decode each input and pass the decompressed representation to a subsequent decoder. The expanding portion is used to capture location information of objects in image to be generated. While only two decoders are shown in the expanding portion of the text-to-image generative model 108 (e.g., decoder 410A and decoder 410B), more or fewer decoders may be implemented by the text-to-image generative model 108.

In some embodiments, between convolution layers of the encoders 404 and decoders 410, residual connections (not shown) are used to provide feature information. For example, given an encoder 404 including two convolutional layers and a pooling layer, the output of the first convolutional layer can be passed as both the input to the second convolutional layer and algorithmically combined with the output of the second convolutional layer.

The connection between the contracting portion and the expanding portion is a skip connection that is used to pass spatial context features extracted from the contracting portion. Because the initial encoders obtain features that are less closely related to the image to be generated than the features obtained by the later encoders, the spatial context information is weighted using self-attention. The attention block 408 is used to attend a single input (e.g., self-attention). In some embodiments, the attention block 408 is used to attend two different inputs (e.g., the text features extracted from the encoder 414 and the spatial context features determined using an encoder of the contracting portion such as encoder 404A2) via cross-attention.

As shown in text-to-image generative model 108, the attention block 408 receives information from the storage manager 110. Specifically, the attention block 408 receives the attention map of previous frames 116. For example, when determining the attention map of frame i=5, the attention map of frame i=4 (e.g., the attention map of the previous frame 116) is passed to the attention block 408. The attention block 408 concatenates the self-attention features of the previous frame (e.g., attention map of the previous frame 116) during the generation of the current frame.

Within the attention block 408, features from the encoders 404 are projected into d-dimensional queries Q, keys K, and values V. The output of the self-attention block 408 at each denoising step t is determined according to Equation (1) below:

$${A}_{t} {V}_{t} , where {A}_{t} = Softmax ( \frac{{Q}_{t} {K}_{t}^{T}}{\sqrt{d}} ) \qquad ( 1 )$$

There is a correlation between the self-attention maps and the motion in a generated frame. If there is no change in the self-attention maps from a first frame to a second frame, the video frames that are generated will correspondingly not include motion between the first frame and the second frame, thereby reducing spurious motion between the first frame and the second frame. Accordingly, generating high-quality frames is dependent on accurate attention maps.

The attention manager 412 can perform operations similar to those operations performed by the attention block 408 described herein. Additionally, the attention manager 412 modifies and corrects the attention maps because the attention maps are correlated with a frame generated by the text-to-image generative model 108. That is, suppressing information in the attention maps corresponds to suppressing generated content determined by the text-to-image generative model 108.

Specifically, the attention manager 412 warps the self-attention features of the previous attention map with the flow from the current frame. The attention manager's 412 application of flow warping improves the temporal coherency across the current frame and previous frames of the video. In operation, the attention manager 412 injects flow information into the self-attention maps by modifying the attention map calculation, as shown below in Equation (2):

$${A}_{t} {V}_{t} , where {\hat{A}}_{t}^{i} = α {A}_{t}^{i} + ( 1 - α ) ( warp ( {A}_{t}^{i - 1} , {f}_{c}^{i} ) ) \qquad ( 2 )$$

In Equation (2) above, the self-attention map for a frame i at denoising step t is recomputed as a linear combination of itself (e.g.,

$${A}_{t}^{i} )$$

and the flow-warped version of the attention map of the previous frame. Alpha (α) in Equation (2) above is a scalar constant that determines the linear combination, and the function warp(·) is a bilinear interpolation function used to apply the flow between the (i−1) frame and the i frame. In some embodiments, alpha is manually determined.

The attention manager 412 can correct the modified attention map by enforcing non-motion regions of the self-attention maps to remain constant. In operation, the attention manager 412 corrects the modified attention maps described in Equation (2) using the self-attention features from the previous frame at the same denoising step (e.g.,

$${A}_{t}^{i - 1} )$$

to weigh the spatial regions corresponding to motion (or zero flow) identified by a binarized flow map for the frame (e.g., M_{f}_{_{c}}). The binarized flow for the frame also modifies the flow-warp injected attention map (e.g.,

$${\hat{A}}_{t}^{i} ) .$$

The corrected attention map determined by the attention manager is mathematically represented in Equation (3) below:

$${\hat{A}}_{tcor}^{i} {V}_{t} , where {\hat{A}}_{tcor}^{i} = ( 1 - {M}_{{f}_{c}} ) {A}_{t}^{i - 1} + {M}_{{f}_{c}} {\hat{A}}_{t}^{i} \qquad ( 3 )$$

In operation, the attention manager 412 corrects the self-attention maps across frames through external information (e.g., flow of current frame 112, mask of flow of current frame 114) to suppress erroneous motion. As a result, the attention manager 412 restricts motion only to the desired regions (e.g., the garment). If an area of the frame is zero flow (as indicated by a value of the binary mask M_{f}_{_{c}} such as “0”), the attention map of the area of the frame does not need any correction or modification. If an area of the frame has a flow (as indicated by a value of the binary mask M_{f}_{_{c}} such as “1”), then the attention manager 412 updates the attention map of the area of the frame with the flow. As a result of the corrected attention map, (e.g., Âⁱ_{tcor}), spurious motion is suppressed by penalizing values in the background region, for instance, that change across frames. That is, the binarized flow map is used to correct the attention map of the previous frame.

As shown, the attention manager 412 modifies the attention maps of the last decoder block in the expanding portion of the UNet architecture of the text-to-image generative model 108. In some embodiments, the last decoder block in the expanding portion of the UNet is highly correlated with the motion of the input normal map 402. In some embodiments, the text-to-image generative model 108 includes additional attention managers. For example, additional attention managers can modify attention maps of decoder blocks in the expanding portion of the UNet architecture (e.g., decoder 410B). In some embodiments, the attention manager 412 modifies a different attention map of the decoder block in the expanding portion of the UNet architecture. For example, the attention manager 412 can replace the attention block 408 associated with the decoder 410B.

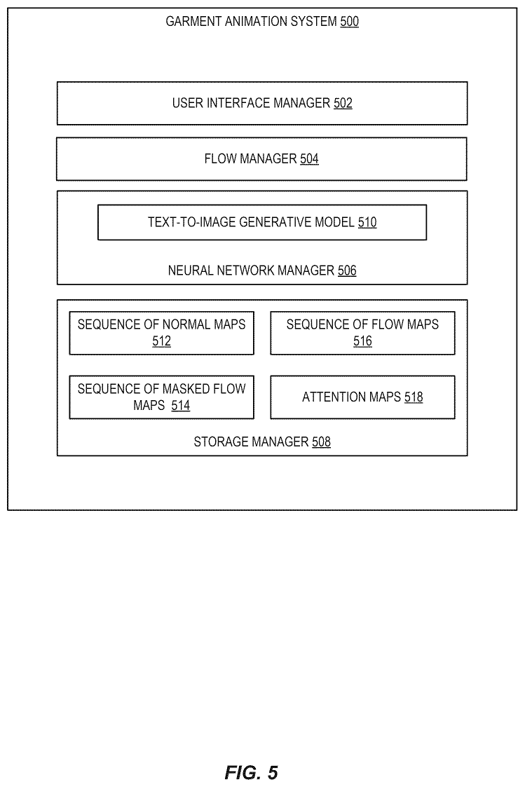

FIG. 5 illustrates a schematic diagram of a garment animation system (e.g., “garment animation system” described above) in accordance with one or more embodiments. As shown, the garment animation system 500 may include, but is not limited to, user interface manager 502, flow manager 504, neural network manager 506, and storage manager 508. The neural network manager 506 includes a text-to-image generative model 501. The storage manager 508 includes sequence of normal maps 512, sequence of flow maps 516, sequence of masked flow maps 514, and attention maps 518.

As illustrated in FIG. 5, the garment animation system 500 includes a user interface manager 502. For example, the user interface manager 502 allows users to provide a text prompt to the garment animation system 500. In some embodiments, the user interface manager 502 provides a user interface through which the user can enter natural language text to describe a scene (e.g., a user wearing a garment). In some embodiments, the user interface manager 502 allows users (e.g., administrators) to provide an input image to the garment animation system 500 and/or animation specifics to the garment animation system. In some embodiments, an administrator can upload the input image from which the sequence of normal are generated as discussed above. Alternatively, or additionally, the user interface may enable the user to download the images from a local or remote storage location (e.g., by providing an address (e.g., a URL or other endpoint) associated with an image source). In some embodiments, the user interface can enable a user to link an image capture device, such as a camera or other hardware to capture image data and provide it to the garment animation system 500.

In some embodiments, the user interface can capture a user's mouse movements, figure movements, or hand movements. For example, the user interface can record the user's mouse movements indicating a direction of garment motion and a speed of garment motion. In some embodiments, a user can interact with an arrow displayed by the user interface manager 502 and the interactions associated with the arrow represent the direction of garment motion and the speed of garment motion. That is, an arrow that is manipulated by a user to be a long arrow represents a faster speed of garment motion. In contrast, an arrow that is manipulated by a user to be a short arrow represents a slower speed of garment motion. In some embodiments, the direction of the arrow (which can be positioned by a user using the user interface for instance) represents the direction of movement of the garment motion.

Additionally, the user interface manager 502 allows users to view a generated animation corresponding to the garment described in the scene. That is, the user interface manager 502 can be used to present a video including a sequence of frames depicting garment motion to the user.

As illustrated in FIG. 5, the garment animation system 500 includes a flow manager 504. The flow manager 504 binarizes a sequence of flow maps. In some embodiments, the flow manager 504 computes a binary mask of each flow map in a sequence of flow maps by thresholding the flow map. As described herein, a flow map can represent the movement of each pixel across a pair of consecutive normal maps using an intensity value of each pixel. To binarize a flow map, the flow manager 504 compares the intensity value of each pixel in the flow map to a threshold.

As illustrated in FIG. 5, the garment animation system 500 also includes a neural network manager 506. Neural network manager 506 may host a plurality of neural networks or other machine learning models, such as text-to-image generative model 510. The neural network manager 506 may include an execution environment, libraries, and/or any other data needed to execute the machine learning models. In some embodiments, the neural network manager 506 may be associated with dedicated software and/or hardware resources to execute the machine learning models. As discussed, text-to-image generative model 510 can be a machine learning model such as a diffusion model. In some embodiments, the text-to-image generative model 510 is a normal-conditioned ControlNet machine learning model. That is, the text-to-image generative model 510 is a ControlNet diffusion model pretrained with normal-maps as the control. The text-to-image generative model 510 generates a frame of a video based on a received text prompt and a normal map. When generating the frame of the video, the text-to-image generative model 510 generates attention maps. As described herein the attention maps correspond to frames of the video (e.g., the garment animation). Accordingly, correcting the attention maps by injecting flow maps, and cross-frame self-attention, correspond to temporally coherent and spurious motion-suppressed frames of the video. The text-to-image generative model 510 generates an image of a video (e.g., a frame), which when played as a sequence, depicts a visual representation of a moving or otherwise animated garment.

Although depicted in FIG. 5 as being hosted by a single neural network manager 506, in various embodiments the neural networks may be hosted in multiple neural network managers and/or as part of different components.

As illustrated in FIG. 5, the garment animation system 500 also includes the storage manager 508. The storage manager 508 maintains data for the garment animation system 500. The storage manager 508 can maintain data of any type, size, or kind as necessary to perform the functions of the garment animation system 500.

The storage manager 508, as shown in FIG. 5, includes the sequence of normal maps 512. Each normal map of the sequence of normal maps 512 captures information about the surface of a garment. Accordingly, a sequence of normal maps 512 can be used to capture garment motion dynamics that involve geometry variations like folds and wrinkles responsive to garment motion. Each normal map of the sequence of normal maps 512 corresponds to a frame of the garment animation. As described herein, normal maps of the sequence of normal maps 512 are used as a condition for a normal-conditioned text-to-image generative model (e.g., ControlNet).

The storage manager 508, as shown in FIG. 5, includes the sequence of flow maps 516. A flow map represents an estimation of per-pixel motion between a pair of consecutive normal maps in the sequence of normal maps 512. In operation, a flow map represents an intensity value of each pixel, where the intensity value of the pixel corresponds to speed of motion of the pixel across a pair of consecutive normal maps. Each flow map in the sequence of flow maps 516 corresponds to each normal map in the sequence of normal maps 512. As described herein, flow maps of the sequence of flow maps 512 are injected into attention maps determined by the text-to-image generative model 510 to correct and modify the attention maps. The storage manager 508, as shown in FIG. 5, includes the sequence of masked flow maps 514. As described herein, the flow manager 504 binarizes each flow map of the sequence of flow maps 516 to create the sequence of masked flow maps 514. Binarized flow maps (e.g., masked flow maps) of the sequence of masked flow maps 514 are injected into attention determined by the text-to-image generative model 510 to correct the attention maps.

The storage manager 508, as shown in FIG. 5, includes the attention maps 518. Attention maps 518 can include the attention maps generated in the UNet architecture of the text-to-image generative model 510, such as those attention maps generated by the attention block. As described herein, an attention map can be generated by an attention block using a projection of features determined by encoders of the UNet architecture. As described herein, there is an attention map determined at one or more denoising steps associated with the generation of each frame of the garment animation. Attention maps 518 stored by the storage manager 508 can include attention maps stored at each denoising step for each frame. In some embodiments, generation of a next frame of the garment animation includes determining an attention map for a denoising step of the next frame and includes using one or more attention maps associated with the same denoising step of the previous frame.

Attention maps 518 can also include modified attention maps determined by attention managers of the UNet architecture of the text-to-image generative model 510. As described herein, modified attention maps warp the self-attention features of the previous attention map with the flow from the current frame. The application of flow warping to an attention map improves the temporal coherency across the current frame and previous frames of the video (e.g., the garment animation).

Attention maps 518 can also include corrected self-attention maps determined by attention managers of the UNet architecture of the text-to-image generative model 510. As described herein, corrected self-attention maps enforce non-motion regions of the self-attention maps. In operation, the corrected self-attention map is a linear combination of attention maps of a previous frame, a binarized flow map, and modified attention maps, where the modified attention maps are based on a linear combination of an attention map and a flow-warped version of the attention map of the previous frame.

Each of the components 502-508 of the garment animation system 500 and their corresponding elements (as shown in FIG. 5) may be in communication with one another using any suitable communication technologies. It will be recognized that although components 502-508 and their corresponding elements are shown to be separate in FIG. 5, any of components 502-508 and their corresponding elements may be combined into fewer components, such as into a single facility or module, divided into more components, or configured into different components as may serve a particular embodiment.

The components 502-508 and their corresponding elements can comprise software, hardware, or both. For example, the components 502-508 and their corresponding elements can comprise one or more instructions stored on a computer-readable storage medium and executable by processors of one or more computing devices. When executed by the one or more processors, the computer-executable instructions of the garment animation system 500 can cause a client device and/or a server device to perform the methods described herein. Alternatively, the components 502-508 and their corresponding elements can comprise hardware, such as a special purpose processing device to perform a certain function or group of functions. Additionally, the components 502-508 and their corresponding elements can comprise a combination of computer-executable instructions and hardware.

Furthermore, the components 502-508 of the garment animation system 500 may, for example, be implemented as one or more stand-alone applications, as one or more modules of an application, as one or more plug-ins, as one or more library functions or functions that may be called by other applications, and/or as a cloud-computing model. Thus, the components 502-508 of the garment animation system 500 may be implemented as a stand-alone application, such as a desktop or mobile application. Furthermore, the components 502-508 of the garment animation system 500 may be implemented as one or more web-based applications hosted on a remote server. Alternatively, or additionally, the components of the garment animation system 500 may be implemented in a suite of mobile device applications or “apps.”

As shown, the garment animation system 500 can be implemented as a single system. In other embodiments, the garment animation system 500 can be implemented in whole, or in part, across multiple systems. For example, one or more functions of the garment animation system 500 can be performed by one or more servers, and one or more functions of the garment animation system 500 can be performed by one or more client devices. The one or more servers and/or one or more client devices may generate, store, receive, and transmit any type of data used by the garment animation system 500, as described herein.

In one implementation, the one or more client devices can include or implement at least a portion of the garment animation system 500. In other implementations, the one or more servers can include or implement at least a portion of the garment animation system 500. For instance, the garment animation system 500 can include an application running on the one or more servers or a portion of the garment animation system 500 can be downloaded from the one or more servers. Additionally or alternatively, the garment animation system 500 can include a web hosting application that allows the client device(s) to interact with content hosted at the one or more server(s).

For example, upon a client device accessing a webpage or other web application hosted at the one or more servers, in one or more embodiments, the one or more servers can provide access to a user interface displayed at a client device. The client device can prompt the user to provide a description of a scene including a garment in natural language text (e.g., a text prompt). Upon receiving the text prompt, the client device can provide the text prompt to the one or more servers, which can automatically perform the methods and processes described herein to generate an animation of a garment. The one or more servers can then provide access to the user interface displayed at the client device to display the video including the animated garment.

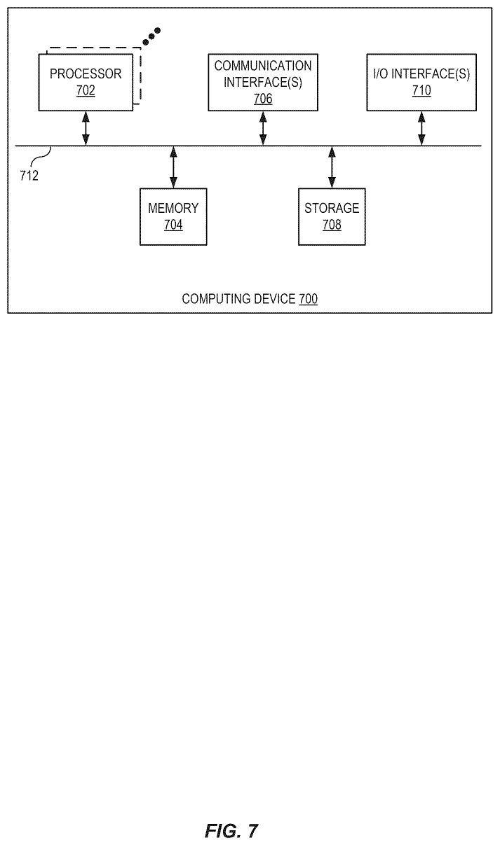

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 7. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 7.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 7.

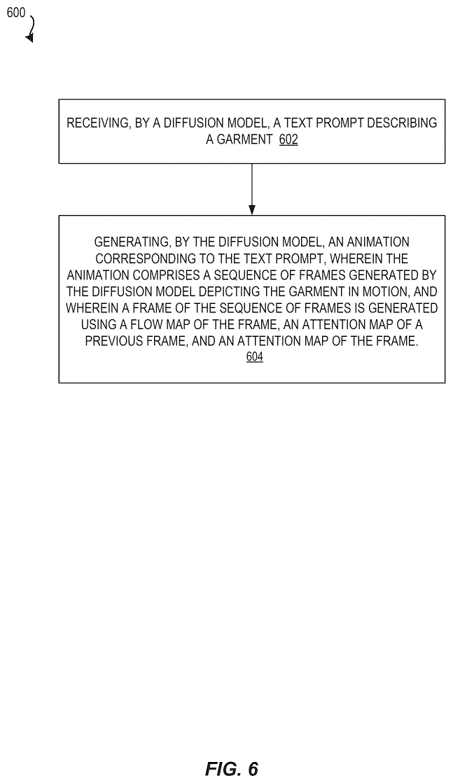

FIGS. 1-5, the corresponding text, and the examples, provide a number of different systems and devices that allows a user to generate an animation of a garment. In addition to the foregoing, embodiments can also be described in terms of flowcharts comprising acts and steps in a method for accomplishing a particular result. For example, FIG. 6 illustrates a flowchart of an exemplary method in accordance with one or more embodiments. The method described in relation to FIG. 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart 600 of a series of acts in a method of generating an animation of a garment in accordance with one or more embodiments. In one or more embodiments, the method 600 is performed in a digital medium environment that includes the garment animation system 500. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of receiving, by a diffusion model, a text prompt describing a garment. In some embodiments, a user enters a natural language description of a garment and an object (such as a person) adorning the garment. Example text prompts can include “a man wearing a striped shirt” or “a women in a red satin dress with flowers.” In some embodiments, the text prompt is received at a run-time. The run-time is a time at which a user indicates an interest in deploying the garment animation system. For example, the user selects an interactive button indicating that the garment animation system is to generate an animation of a garment described in the text prompt. In some embodiments, the garment animation system responsible for generating the animation of the garment is deployed in a pipeline (e.g., one or more external systems call the garment animation system to generate a garment animation). Run-time is distinguished from an initialization time in which the garment animation system receives and/or generates normal maps. Also during the initialization time, the garment animation system generates and/or receives flow maps corresponding to the normal maps. In some embodiments, during the initialization time, the garment animation system binarizes the flow maps, generating flow masks.

As illustrated in FIG. 6, the method 600 includes an act 602 of generating, by the diffusion model, an animation corresponding to the text prompt. The animation includes a sequence of frames generated by the diffusion model depicting the garment in motion. In operation, the diffusion model, such as a normal-conditioned ControlNet, generates each frame of the sequence of frames.

A frame of the sequence of frames is generated using a flow map of the frame, an attention map of a previous frame, and an attention map of the frame. An attention map can be generated by an attention block of the diffusion model using a projection of features determined by encoders of the diffusion model. As described herein, there is an attention map determined at one or more denoising steps associated with the generation of each frame of the garment animation. In some embodiments, generation of a next frame of the garment animation includes determining an attention map for a denoising step of the next frame and includes using one or more attention maps associated with the same denoising step of the previous frame.

A flow map represents an estimation of per-pixel motion between a pair of consecutive normal maps in the sequence of normal maps. In operation, a flow map represents an intensity value of each pixel, where the intensity value of the pixel corresponds to speed of motion of the pixel across a pair of consecutive normal maps. A flow map corresponds to a normal map used to generate a frame of the sequence of frames. Flow maps are injected into attention maps determined by the diffusion model to correct and modify the attention maps generated by the diffusion model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that one or more computing devices such as the computing device 700 may implement the garment animation system. As shown by FIG. 7, the computing device can comprise a processor 702, memory 704, one or more communication interfaces 706, a storage device 708, and one or more I/O devices/interfaces 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 708 and decode and execute them. In various embodiments, the processor(s) 702 may include one or more central processing units (CPUs), graphics processing units (GPUs), field programmable gate arrays (FPGAs), systems on chip (SoC), or other processor(s) or combinations of processors.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The computing device 700 can further include one or more communication interfaces 706. A communication interface 706 can include hardware, software, or both. The communication interface 706 can provide one or more interfaces for communication (such as, for example, packet-based communication) between the computing device and one or more other computing devices 700 or one or more networks. As an example and not by way of limitation, communication interface 706 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

The computing device 700 includes a storage device 708 includes storage for storing data or instructions. As an example, and not by way of limitation, storage device 708 can comprise a non-transitory storage medium described above. The storage device 708 may include a hard disk drive (HDD), flash memory, a Universal Serial Bus (USB) drive or a combination these or other storage devices. The computing device 700 also includes one or more input or output (“I/O”) devices/interfaces 710, which are provided to allow a user to provide input to (such as user strokes), receive output from, and otherwise transfer data to and from the computing device 700. These I/O devices/interfaces 710 may include a mouse, keypad or a keyboard, a touch screen, camera, optical scanner, network interface, modem, other known I/O devices or a combination of such I/O devices/interfaces 710. The touch screen may be activated with a stylus or a finger.

The I/O devices/interfaces 710 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 710 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving, by a diffusion model, a text prompt describing a garment; and
generating, by the diffusion model, an animation corresponding to the text prompt, wherein the animation comprises a sequence of frames generated by the diffusion model depicting the garment in motion, and wherein a frame of the sequence of frames is generated using a flow map of the frame, an attention map of a previous frame, and an attention map of the frame.

2. The method of claim 1, further comprising:
generating the frame of the sequence of frames using a modified attention map, wherein the modified attention map is a linear combination of the attention map of the frame and a flow-warped version of the attention map of the previous frame, wherein the flow-warped version of the attention map of the previous frame is based on the attention map of the previous frame and the flow map of the frame.

3. The method of claim 1, further comprising:
generating a binarized flow map of the frame using the flow map of the frame, wherein the frame of the sequence of frames is generating using the flow map of the frame, the attention map of the previous frame, the attention map of the frame, and the binarized flow map of the frame.

4. The method of claim 3, further comprising:
comparing an intensity of a pixel value of the flow map of the frame to a threshold to obtain the binarized flow map of the frame.

5. The method of claim 3, further comprising:
correcting the attention map of the previous frame by weighing a spatial region of the attention map of the previous frame corresponding to flow identified by the binarized flow map of the frame.

6. The method of claim 3, further comprising:
correcting a modified attention map of the frame by weighing the modified attention map using the binarized flow map of the frame.

7. The method of claim 1, wherein a noise initialization is used to generate a frame of the sequence of frames, and each frame of the sequence of frames is generated using the noise initialization.

8. A non-transitory computer-readable medium storing executable instructions, which when executed by a processing device, cause the processing device to perform operations comprising:
receiving, by a diffusion model, a text prompt describing a garment; and
generating, by the diffusion model, an animation corresponding to the text prompt, wherein the animation comprises a sequence of frames generated by the diffusion model depicting the garment in motion, and wherein a frame of the sequence of frames is generated using a flow map of the frame, an attention map of a previous frame, and an attention map of the frame.

9. The non-transitory computer-readable medium of claim 8, storing instructions that further cause the processing device to perform operations comprising:
generating the frame of the sequence of frames using a modified attention map, wherein the modified attention map is a linear combination of the attention map of the frame and a flow-warped version of the attention map of the previous frame, wherein the flow-warped version of the attention map of the previous frame is based on the attention map of the previous frame and the flow map of the frame.

10. The non-transitory computer-readable medium of claim 8, storing instructions that further cause the processing device to perform operations comprising:
generating a binarized flow map of the frame using the flow map of the frame, wherein the frame of the sequence of frames is generating using the flow map of the frame, the attention map of the previous frame, the attention map of the frame, and the binarized flow map of the frame.

11. The non-transitory computer-readable medium of claim 10, storing instructions that further cause the processing device to perform operations comprising:
comparing an intensity of a pixel value of the flow map of the frame to a threshold to obtain the binarized flow map of the frame.

12. The non-transitory computer-readable medium of claim 10, storing instructions that further cause the processing device to perform operations comprising:
correcting the attention map of the previous frame by weighing a spatial region of the attention map of the previous frame corresponding to flow identified by the binarized flow map of the frame.

13. The non-transitory computer-readable medium of claim 10, storing instructions that further cause the processing device to perform operations comprising:
correcting a modified attention map of the frame by weighing the modified attention map using the binarized flow map of the frame.

14. The non-transitory computer-readable medium of claim 8, wherein a noise initialization is used to generate a frame of the sequence of frames, and each frame of the sequence of frames is generated using the noise initialization.

15. A system comprising:
a memory component; and
a processing device coupled to the memory component, the processing device to perform operations comprising:
receiving an image depicting a garment and a text prompt;
generating, using the image, a sequence of frames depicting motion of the garment
generating, by a diffusion model, an animation corresponding to the text prompt, wherein the animation comprises the sequence of frames; and
presenting, to a user via a user interface, the animation, wherein the animation comprises an animated representation of the garment, wherein the animation of the garment is at least based on a flow map of a frame of the sequence of frames, an attention map of a previous frame, and an attention map of the frame.

16. The system of claim 15, wherein the processing device performs further operations comprising:
generating the frame of the sequence of frames using a modified attention map, wherein the modified attention map is a linear combination of the attention map of the frame and a flow-warped version of the attention map of the previous frame, wherein the flow-warped version of the attention map of the previous frame is based on the attention map of the previous frame and the flow map of the frame.

17. The system of claim 15, wherein the processing device performs further operations comprising:
generating a binarized flow map of the frame using the flow map of the frame, wherein the frame of the sequence of frames is generating using the flow map of the frame, the attention map of the previous frame, the attention map of the frame, and the binarized flow map of the frame.

18. The system of claim 17, wherein the processing device performs further operations comprising:
correcting the attention map of the previous frame by weighing a spatial region of the attention map of the previous frame corresponding to flow identified by the binarized flow map of the frame.

19. The system of claim 17, wherein the processing device performs further operations comprising:
correcting a modified attention map of the frame by weighing the modified attention map using the binarized flow map of the frame.

20. The system of claim 15, wherein a noise initialization is used to generate a frame of the sequence of frames, and each frame of the sequence of frames is generated using the noise initialization.
